(19) United States
(12) Patent Application Publication
(10) Pub. No.: US 2026/0124859 A1
(43) Pub. Date: May 7, 2026

(54) TIRE COMPRISING A TREAD WITH UNIFORM WEAR AND REDUCED NOISE

(71) Applicant: COMPAGNIE GENERALE DES ETABLISSEMENTS MICHELIN, Clermont-Ferrand (FR)

(72) Inventors: PATRICK BERVAS, Clermont-Ferrand (FR); PASCAL CHOVE, Clermont-Ferrand (FR); AYAKA IMAMURA, Clermont-Ferrand (FR); MATHIEU GRANDEMANGE, Clermont-Ferrand (FR); BENOIT DURAND-GASSELIN, Clermont-Ferrand (FR)

(21) Appl. No.: 19/117,862

(22) PCT Filed: Sep. 25, 2023
(86) PCT No.: PCT/EP2023/076401

§ 371 Date: Apr. 2, 2025

(30) Foreign Application Priority Data
Oct. 3, 2022 (FR) FR2210082

(51) Int. Cl. B60C 11/03

(52) U.S. Cl. CPC B60C 11/0304; B60C 2011/0355; B60C 2011/0365

(57) ABSTRACT

A tire (10) comprises N1<N2 first and second major transverse cuts (81, 82) that are formed in axially lateral portions (P1, P2) and extend over an axial width greater than or equal to 50% of the respective axial width of each first and second axially lateral portion (P1, P2) and have a depth greater than or equal to 50% of the tread pattern height of the tire (10). At least 50% of the first major transverse cuts (81) and at least 50% of the second major transverse cuts (82) have, in at least one zone, a width less than or equal to 0.50 mm. There is at least one central rib j (63, 64) comprising Mj>1 major transverse cuts (73, 74) formed in the central rib j such that N1<Mj<N2.

The present invention relates to a tyre for a passenger vehicle. A tyre is understood to be a casing intended to form a cavity by cooperating with a support element, for example a rim, this cavity being able to be pressurized to a pressure higher than atmospheric pressure. A tyre according to the invention has a structure of substantially toroidal shape exhibiting symmetry of revolution about a main axis of the tyre.

A passenger vehicle tyre sold under the MICHELIN® trade name in the PRIMACY 4® range is known from the prior art. Such a tyre comprises a tread intended to come into contact with the ground via a tread surface when the tyre is running.

The tread comprises main circumferential cuts having a depth greater than or equal to 50% of the tread pattern height and comprising first and second axially outer main circumferential cuts arranged axially on either side of the median plane of the tyre. The first and second axially outer main circumferential cuts are the axially outermost main circumferential cuts of the tread.

The tread comprises a first axially lateral portion arranged axially on the outside of the first axially outer main circumferential cut, and a second axially lateral portion arranged axially on the outside of the second axially outer main circumferential cut. The tread also comprises transverse cuts formed at least partially in each first and second axially lateral portion.

In spite of having excellent performance aspects, this prior art tyre exhibits uneven wear. Specifically, depending on the vehicle to which this tyre is fitted, one of the first and second axially lateral portions is found to wear down more rapidly than the other. When the wear is such that the tread reaches the regulatory wear threshold, it is then necessary to change the tyre, even though there is still a significant quantity of material able to be worn down on the rest of the tyre.

Therefore, the aim of the invention is to increase the service life of the tyre by reducing the uneven wearing of the tread between the first and second axially lateral portions.

To that end, the invention relates to a tyre comprising a tread intended to come into contact with the ground via a tread surface when the tyre is running, the tread comprising:
main circumferential cuts having a depth greater than or equal to 50% of the tread pattern height, comprising first and second axially outer main circumferential cuts arranged axially on either side of the median plane of the tyre, the first and second axially outer main circumferential cuts being the axially outermost main circumferential cuts of the tread,
a first axially lateral portion arranged axially on the outside of the first axially outer main circumferential cut and extending axially from a first axial edge of the tread surface to an axially outer edge of the first axially outer main circumferential cut,
a second axially lateral portion arranged axially on the outside of the second axially outer main circumferential cut and extending axially from a second axial edge of the tread surface to an axially outer edge of the second axially outer main circumferential cut,
the first axially lateral portion comprising N1 first transverse cuts formed in the first axially lateral portion,
the second axially lateral portion comprising N2 second transverse cuts formed in the second axially lateral portion, where N2>N1,
each first and second transverse cut, referred to as major transverse cut, extending over an axial width greater than or equal to 50% of the respective axial width of each first and second axially lateral portion and having a depth greater than or equal to 50% of the tread pattern height of the tyre,
at least 50% of the first major transverse cuts and at least 50% of the second major transverse cuts having, in at least one zone, a width less than or equal to 0.50 mm,
the tyre comprising k≥1 central rib(s) i delimited axially by first and second axially adjacent main circumferential cuts, the or each central rib i comprising Mi>1 transverse cuts formed in said central rib i, each transverse cut formed in said central rib i, referred to as major transverse cut, extending over an axial width greater than or equal to 50% of the axial width of said central rib i and having a depth greater than or equal to 50% of the tread pattern height of the tyre,
wherein, in the tyre, there is at least one central rib j comprising Mj>1 major transverse cuts formed in said central rib j such that N1<Mj<N2.

The invention makes it possible to extend the service life of the tyre by making the wearing of the tread more even between the first and second axially lateral portions while reducing the noise generated by the tread.

Specifically, the inventors behind the invention have discovered that the stiffest portions of the tread are the portions which wear down most rapidly, namely because the engine torque passes through the stiffest portions of the tread. When there is a significant difference in stiffness between two portions of the tread, as is the case for the prior art tyre described above, uneven wear is observed, resulting in a shorter service life. The difference in stiffness is explained, in the case of the prior art tyre, by the greater number N2 of second major transverse cuts formed in the second axially lateral portion compared with the smaller number N1 of first major transverse cuts formed in the first axially lateral portion. Specifically, on account of the relatively high number of second cuts, the second axially lateral portion is less stiff than the first axially lateral portion.

In order to reduce or even eliminate this more rapid wearing of the first axially lateral portion, the inventors had the idea to conceal the lower stiffness of the second axially lateral portion by preventing the relative movements of the blocks separated by the second major transverse cuts by creating at least one zone (the one having a width less than or equal to 0.50 mm, preferably less than or equal to 0.40 mm, and more preferably less than or equal to 0.35 mm) between the leading and trailing faces of a significant number (at least 50%) of second major transverse cuts when the tyre is in operation. Specifically, by virtue of this zone, it is easier to immobilize the blocks bearing the leading and trailing faces when the tyre is in operation, this having the effect of making this second axially lateral portion stiffer. In the same way, the blocks separated by the first major transverse cuts are also immobilized. Thus, independently of the number of cuts in the first and second axially lateral portions, each of these first and second axially lateral portions is stiffened in a comparable manner such that there is even wear between the first and second axially lateral portions.

The value of 0.50 mm was determined by the inventors as the value below which the coming into contact of the leading and trailing faces was observed under the vast majority of running conditions observed (load, speed, inflation pressure, etc.). Above this value of 0.50 mm, the leading and trailing faces may come into contact with one another, but under extreme running conditions that do not reflect normal use of the tyre.

The zone in which the width is less than or equal to 0.50 mm, preferably less than or equal to 0.40 mm, and more preferably less than or equal to 0.35 mm, may be reduced to two points on the leading and trailing faces that are distant from one another by a distance less than of equal to 0.50 mm, preferably less than or equal to 0.40 mm, and more preferably less than or equal to 0.35 mm, or may extend over surfaces that are not reduced to two points on the leading and trailing faces. In this case of surfaces that are not reduced to two points on the leading and trailing faces, a plurality of points on each leading and trailing face are distant from one another in pairs by a distance less than or equal to 0.50 mm, preferably less than or equal to 0.40 mm, and more preferably less than or equal to 0.35 mm.

The feature whereby N2/N1>1 makes it possible in particular to reduce the noise generated by the tyre. Specifically, each axial portion of the tread generates noise, the harmonics of which are centred on a frequency that depends in particular on the number and the distribution of the transverse cuts formed in this axial portion of the tread. In order to reduce the noise generated by the tyre, the inventors discovered that it was effective to spread the frequencies of the harmonics of the different axial portions of the tread and therefore to spread the acoustic energy generated by the tyre. In order to spread these frequencies, the tyre according to the invention is such that the first and second axially lateral portions have different numbers of major transverse cuts, making it possible to differentiate the harmonics associated with each first and second axially lateral portion and therefore to reduce the noise generated by the tyre. Similarly, the central rib j in which the Mj major transverse cuts are formed makes it possible, by virtue of the feature whereby N1<Mj<N2, to spread the acoustic energy generated by the tyre and therefore to reduce the noise generated by the tyre.

Conventionally, the tread surface is axially delimited by the first and second axial edges. The first and second axial edges of the tread surface are determined on a tyre mounted on a nominal rim and inflated to the nominal pressure in accordance with the European Tyre and Rim Technical Organisation, or “ETRTO”, standard of 2021. The first and second axial edges of the tread surface are arranged on either side of the median plane of the tyre and formed by lines substantially parallel to the circumferential direction of the tyre. If there is an obvious boundary between the tread surface and the rest of the tyre, the first and second axial edges of the tread surface are simply determined. If the tread surface is continuous with the outer surfaces of the sidewalls of the tyre, the first and second axial edges could, for example, be determined by taking into consideration that each first and second axial edge passes, in each meridian section plane, through the point at which the angle between the tangent to the tread surface and a straight line parallel to the axial direction passing through this point is equal to 30°. When, in a meridian section plane, there are several points at which said angle is equal, in terms of absolute value, to 30°, the radially outermost point is used.

The or each first and second axially lateral portion of the tread may, of course, comprise further transverse cuts other than the first and second major transverse cuts. The or each first and second axially lateral portion of the tread may also comprise further cuts other than the major or non-major transverse cuts, for example circumferential cuts.

A cut or a cut portion has, on the tread surface, two main characteristic dimensions: a width and a curvilinear length such that the curvilinear length is at least equal to twice the width. A cut is therefore delimited by at least two main lateral faces that determine its curvilinear length and are connected by a bottom, the two main lateral faces being distant from one another by a non-zero distance referred to as the width of the cut.

On a new tyre, the width of a cut is the maximum distance between the two main lateral faces that is measured, by default and when the cut is not chamfered, at a radial dimension coincident with the tread surface and, by default and when the cut is chamfered, at the radially outermost radial dimension of the cut that is radially inside the chamfer. The width is measured substantially perpendicularly to the main lateral faces. If a width other than the default width is specified, for example a width at a particular dimension, the width is equal to the smallest distance between the two main lateral faces at the particular dimension of the cut.

On a new tyre, the depth of a cut is the maximum radial distance between the bottom of the cut and its projection onto the ground when the tyre is running. The maximum value for the depths of the cuts is referred to as the tread pattern height.

A cut may be transverse or circumferential.

A transverse cut is such that the cut extends in a mean direction that forms an angle strictly greater than 30°, preferably greater than or equal to 45° with the circumferential direction of the tyre, that is to say one that forms an angle less than or equal to 60°, preferably strictly less than 45° with the axial direction of the tyre. The mean direction is the shortest curve joining the two ends of the cut and parallel to the tread surface. A transverse cut may be continuous, i.e. not interrupted by a tread block or another cut, such that the two main lateral faces determining its length are uninterrupted along the length of the transverse cut. A transverse cut may also be discontinuous, i.e. interrupted by one or more tread blocks and/or one or more cuts, such that the two main lateral faces determining its length are interrupted by one or more tread blocks and/or one or more cuts.

A circumferential cut is such that the cut extends in a mean direction that forms an angle less than or equal to 30°, preferably less than or equal to 10° with the circumferential direction of the tyre, that is to say one that forms an angle strictly greater than 60°, preferably strictly greater than 80° with the axial direction of the tyre. The mean direction is the shortest curve joining the two ends of the cut and parallel to the tread surface. In the case of a continuous circumferential cut, the two ends coincide with each other and are joined by a curve that makes a full circuit around the tyre. A circumferential cut may be continuous, i.e. not interrupted by a tread block or another cut, such that the two main lateral faces determining its length are uninterrupted over a full circuit around the tyre. A circumferential cut may also be discontinuous, i.e. interrupted by one or more tread blocks and/or one or more cuts, such that the two main lateral faces determining its length are interrupted by one or more tread blocks and/or one or more cuts over a full circuit around the tyre.

In the case of a transverse cut, the lateral faces are referred to as the leading face and trailing face, and are each provided respectively with a leading edge and a trailing edge, the leading edge being the edge which, for a given circumferential line, enters the contact patch before the edge of the trailing edge.

In embodiments for optionally improving the braking on dry ground, the or each transverse cut is chamfered. A chamfer of a transverse cut may be a straight chamfer or a rounded chamfer. A straight chamfer is formed by a planar face that is inclined with respect to the leading or trailing face that it extends as far as the leading or trailing edge circumferentially delimiting the transverse cut. A rounded chamfer is formed by a curved face that merges tangentially into the leading or trailing face that it extends. A chamfer of a transverse cut is characterized by a height and a width that are respectively equal to the radial distance and to the distance in a direction perpendicular to the leading or trailing faces between the common point shared by the leading or trailing face extended by the chamfer, and the leading or trailing edge circumferentially delimiting the transverse cut.

In some embodiments for optionally improving the braking on wet ground and also the transverse grip on dry ground, at least one of the main circumferential cuts is chamfered. A chamfer of a circumferential cut may be a straight chamfer or a rounded chamfer. A straight chamfer is formed by a planar face that is inclined with respect to the axially inner and outer face that it extends up to the axially inner or outer edge axially delimiting the circumferential cut. A rounded chamfer is formed by a curved face that merges tangentially into the axially inner or outer face that it extends. A chamfer of a circumferential cut is characterized by a height and a width that are respectively equal to the radial distance and to the axial distance between the common point shared by the axially inner or outer face extended by the chamfer, and the axially inner or outer edge axially delimiting the circumferential cut.

The tyre according to the invention has a substantially toroidal shape about an axis of revolution substantially coincident with the axis of rotation of the tyre. This axis of revolution defines three directions conventionally used by those skilled in the art: an axial direction, a circumferential direction and a radial direction.

The expression “axial direction” means the direction substantially parallel to the axis of revolution of the tyre, i.e. the axis of rotation of the tyre.

The expression “circumferential direction” means the direction which, in each meridian plane, is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to that axis.

The expression “median plane of the tyre” (denoted M) means the plane perpendicular to the axis of rotation of the tyre which is situated axially mid-way between the two beads and passes through the axial middle of the crown reinforcement.

The expression “equatorial circumferential plane of the tyre” means, in a meridian section plane, the plane passing through the equator of the tyre, perpendicular to the median plane and to the radial direction. The equator of the tyre is, in a meridian section plane (plane perpendicular to the circumferential direction and parallel to the radial and axial directions), the axis that is parallel to the axis of rotation of the tyre and situated equidistantly between the radially outermost point of the tread that is intended to be in contact with the ground and the radially innermost point of the tyre that is intended to be in contact with a support, for example a rim.

The expression “meridian plane” means a plane parallel to and containing the axis of rotation of the tyre and perpendicular to the circumferential direction.

The expressions “radially inner/inside” and “radially outer/outside” mean closer to the axis of rotation of the tyre and further away from the axis of rotation of the tyre, respectively. The expressions “axially inner/inside” and “axially outer/outside” mean closer to the median plane of the tyre and further away from the median plane of the tyre, respectively.

The term “bead” means the portion of the tyre intended to allow the attachment of the tyre to a mounting support, for example a wheel comprising a rim. Thus, each bead is in particular intended to be in contact with a flange of the rim allowing it to be attached.

Any interval of values denoted by the expression “between a and b” represents the range of values extending from more than a to less than b (i.e. excluding the limits a and b), whereas any interval of values denoted by the expression “from a to b” means the range of values extending from a to b (i.e. including the strict limits a and b).

In preferred embodiments of the invention, the tyres are intended for passenger vehicles as defined in accordance with the European Tyre and Rim Technical Organisation, or “ETRTO”, standard of 2021. Such a tyre has a cross section in a meridian section plane that is characterized by a section height H and a nominal section width S within the meaning of the European Tyre and Rim Technical Organisation, or “ETRTO”, standard of 2021, such that the ratio H/S, expressed as a percentage, is at most equal to 90, preferably at most equal to 70, and is at least equal to 30, and the nominal section width S is at least equal to 115 mm, preferably at least equal to 175 mm, and at most equal to 385 mm, preferably at most equal to 315 mm. Moreover, the diameter at the flange D, defining the diameter of the rim on which the tyre is mounted, is at least equal to 12 inches, preferably at least equal to 16 inches and at most equal to 24 inches.

In preferred embodiments of the invention, the tyres are “summer” tyres. Summer tyres are understood to be tyres that are not “4-season” or “all-season” tyres, or “winter” tyres.

Winter tyres are in particular identified by an M+S marking (M+S being short for “Mud+Snow”) and/or a 3PMSF marking (3PMSF being short for “3 Peak Mountain Snow Flake”). 4-season or all-season tyres also have M+S and/or 3PMSF markings on account of their performance on snow. Thus, a summer tyre does not have an M+S marking or a 3PMSF marking.

In embodiments for making the wear between the first and second axially lateral portions even more even, at least 75% of the first major transverse cuts and at least 75% of the second major transverse cuts, and preferably each first major transverse cut and each second major transverse cut has/have, in at least one zone, a width less than or equal to 0.35 mm.

Optionally and preferably, at least 50% of the first major transverse cuts and at least 50% of the second major transverse cuts have, in at least one zone, a width less than or equal to 0.40 mm, and more preferably less than or equal to 0.35 mm. By decreasing the width of the zone, the coming into contact of the leading and trailing faces is made even easier.

Optionally and preferably, at least 75% of the first major transverse cuts and at least 75% of the second major transverse cuts, and preferably each first major transverse cut and each second major transverse cut has/have, in at least one zone, a width less than or equal to 0.40 mm, and more preferably less than or equal to 0.35 mm.

Optionally and preferably, the zone extends over at least 10% of the height and along at least 10% of the length of at least 50% of the first major transverse cuts and of at least 50% of the second major transverse cuts. By increasing the height and the length along which the blocks are able to come into contact with one another, the coming into contact of the leading and trailing faces is made even easier.

Optionally and preferably, the zone extends over a continuous surface representing at least 10%, preferably at least 20% of the surface of each leading and trailing face of at least 50% of the first major transverse cuts and of at least 50% of the second major transverse cuts. Thus, by virtue of a continuous surface, the capability of the leading and trailing faces to come into contact with respect to spot-like contact points is maximized.

Advantageously, the zone extends over a continuous surface representing at most 80%, preferably at most 50% of the surface of each leading and trailing face of at least 50% of the first major transverse cuts and of at least 50% of the second major transverse cuts.

Even more preferably, the zone extends over a continuous surface representing at least 10%, preferably at least 20% and at most 80%, preferably at most 50% of the surface of each leading and trailing face of at least 75% and very preferably of each of the first major transverse cuts and of at least 75% and very preferably of each of the second major transverse cuts.

In preferred and optional embodiments, each first and second major transverse cut has a radially median portion, a radially outer portion arranged radially on the outside of the radially median portion, and a radially inner portion arranged radially on the inside of the radially median portion, the radially median portion extending radially over a height equal to 50% of the height of said first and second major transverse cut, each radially inner portion and radially outer portion extending radially over a height equal to 25% of the height of said first and second major transverse cut, and the zone of at least 50% of the first major transverse cuts and of at least 50% of the second major transverse cuts, preferably of at least 75% of the first major transverse cuts and of at least 75% of the second major transverse cuts, and more preferably each of the first and second major transverse cuts is situated at least partially in the median portion.

This ensures that the contact between the leading face and the trailing face occurs in the median portion. This thus allows the first and second major cuts to have a relatively great width in the other portions, in particular in the radially outer portion, thereby making it possible to increase the area void ratio.

In certain embodiments, at least 50% of the first major transverse cuts and at least 50% of the second major transverse cuts, preferably at least 75% of the first major transverse cuts and at least 75% of the second major transverse cuts, and more preferably each of the first and second major transverse cuts has/have a radially inner portion and a radially outer portion arranged radially on the outside of the radially inner portion, the radially inner portion being the radially innermost portion of said first and second major transverse cut and the radially outer portion being the outermost portion of said first and second major transverse cut, the radially inner portion having a maximum width strictly greater than the maximum width of the radially outer portion. By using major transverse cuts having a radially variable maximum width, the appearance of chunking of the blocks is minimized, in particular in the second axially lateral portion.

In advantageous but optional embodiments, the tyre has an inner side and an outer side that are imposed when the tyre is mounted on a vehicle, the first axially lateral portion is arranged on the same side of the median plane as the outer side, and the second axially lateral portion is arranged on the same side of the median plane as the inner side.

The expression “inner and outer sides that are imposed when the tyre is mounted on the vehicle” means that the tyre is designed so that one of its sides is arranged on the inner side and the other of its sides is arranged on the outer side. This orientation imposed by the tyre manufacturer makes it possible to ensure that the tyre operates as expected. Specifically, the mounting of a tyre with an orientation different from the one imposed by the manufacturer could result in dangerous behaviour of the vehicle. The expression “outer side” means the side of the tyre that is entirely visible from the outside of the vehicle when the tyre is mounted on the vehicle. The expression “inner side” means the side of the tyre that faces the wheel arch of the vehicle on which it is mounted. Generally, the tyre has a marking indicating the inner side and the outer side.

In advantageous but optional embodiments, each first and second major transverse cut extends axially from respectively each first and second axial edge of the tread surface until opening respectively into each first and second axially outer main circumferential cut. The mobility of the blocks of the first and second axially lateral portions is thus promoted, thereby improving the flattening of the tyre and consequently the rolling resistance.

In other embodiments, it could be envisaged that each first major transverse cut and/or each second major transverse cut does not open respectively into each first and second axially outer main circumferential cut that is adjacent thereto. In these variants, the major transverse cuts are said to be blind.

In advantageous embodiments, N2/N1≥1.30 and preferably N2/N1≥1.50. By further differentiating the number of first and second major transverse cuts formed respectively in each first and second axially lateral portion, the noise generated by the tyre is reduced even further.

Advantageously, N2/N1≥2.00, and preferably N2/N1≤1.75. By excessively differentiating the number of first and second major transverse cuts formed respectively in each first and second axially lateral portion, a relatively significant difference would be created between the stiffnesses of the first and second axially lateral portions, and this would increase the risk of uneven wear.

In preferred variants, the ratio C/N2 ranges from 14 to 20, preferably from 16 to 19. In other preferred variants that are compatible with the above preferred variants, the ratio C/N1 ranges from 24 to 30, preferably from 27 to 29. In these ratios, C is the value of the circumference of the tyre when not mounted and not inflated, expressed in millimetres.

In advantageous but optional embodiments, each major transverse cut formed in each central rib i extends axially from each first main circumferential cut until opening into each second main circumferential cut. The mobility of the blocks of each central rib is thus promoted, thereby improving the flattening of the tyre and consequently the rolling resistance.

In optional and advantageous embodiments, with each central rib i other than the central rib j comprising Mm>1 major transverse cuts that are formed in said central rib i other than the central rib j and extend over an axial width greater than or equal to 50% of the axial width of said central rib i other than the central rib j and have a depth greater than or equal to 50% of the tread pattern height of the tyre, each central rib i other than the central rib j is such that N1≤Mm≤Mj<N2 or N1<Mj≤Mm≤N2. Thus, the acoustic energy generated by the tyre is thus spread even more and the noise generated by the tyre is therefore reduced.

In certain variants, Mi=Mm, meaning that all the transverse cuts formed in said central rib i are major transverse cuts. In other variants, Mi>Mm, meaning that some of the transverse cuts formed in said central rib i are not major transverse cuts.

In advantageous and optional variants, N2/Mj≥1.15 and Mj/N1≥1.15 and preferably N2/Mj≥1.25 and Mj/N1≥1.25. By further differentiating the number of Mj major transverse cuts compared with the numbers of first and second major transverse cuts formed respectively in each first and second axially lateral portion, the noise generated by the tyre is reduced even further.

Advantageously, N2/Mj≤1.75 and Mj/N1≤1.75 and preferably N2/Mj≤51.50 and Mj/N1≤1.50. By excessively differentiating the number of major transverse cuts formed in the central rib j in which the Mj major transverse cuts are formed, a relatively significant difference would be created between the stiffnesses of the first and second axially lateral portions, on the one hand, and the central rib j in which the Mj major transverse cuts are formed, on the other hand, and this would increase the risk of uneven wear.

In preferred variants, the ratio C/Mj ranges from 18 to 23, preferably from 20 to 23. As before, C is the value of the circumference of the tyre when not mounted and not inflated, expressed in millimetres.

In preferred and optional embodiments, N1, N2 and Mj are such that:

$$\begin{matrix}0.4 \leq [ ( N 1 / R 1 ) - ( Mj \times Rj ) ] / [ ( Mj / Rj ) - ( N 1 \times R 1 ) ] \leq 0.6 , \\ 0.4 \leq [ ( Mj / Rj ) - ( N 2 \times R 2 ) ] / [ ( N 2 / R 2 ) - ( Mj \times Rj ) ] \leq 0.6 ,\end{matrix}$$

where:
R1 is the pitch ratio equal to the ratio between the minimum distance between two first circumferentially consecutive major transverse cuts and the maximum distance between two first circumferentially consecutive major transverse cuts,
R2 is the pitch ratio equal to the ratio between the minimum distance between two second circumferentially consecutive major transverse cuts and the maximum distance between two second circumferentially consecutive major transverse cuts,
Rj is the pitch ratio equal to the ratio between the minimum distance between two circumferentially consecutive major transverse cuts of the or each central rib j and the maximum distance between two circumferentially consecutive major transverse cuts of said or each central rib j.

In these preferred embodiments, levels of acoustic overlap are determined between the first axially outer portion and the or each central rib j, on the one hand, and the second axially outer portion and the or each central rib j, on the other hand. The lower these levels of overlap, the more the acoustic energy is spread, thereby making it possible to reduce the noise generated by the tyre. Nevertheless, it is preferable not to have levels of overlap that are too small, since this increases the risk of generating a frequency modulation, giving rise to beating noise.

In preferred and optional embodiments, N1, N2 and Mj are such that 0.50≤[Min(N1×R1; N2×R2; Mj×Rj)/Max(N1/R1; N2/R2; Mj/Rj)]\hat{ }(0.5)≤0.60, where:
R1 is the pitch ratio equal to the ratio between the minimum distance between two first circumferentially consecutive major transverse cuts and the maximum distance between two first circumferentially consecutive major transverse cuts,
R2 is the pitch ratio equal to the ratio between the minimum distance between two second circumferentially consecutive major transverse cuts and the maximum distance between two second circumferentially consecutive major transverse cuts,
Rj is the pitch ratio equal to the ratio between the minimum distance between two circumferentially consecutive major transverse cuts of the or each central rib j and the maximum distance between two circumferentially consecutive major transverse cuts of said or each central rib j,
Min(N1×R1; N2×R2; Mj×Rj) is the minimum value of the product of the number of major transverse cuts and the pitch ratio of the first and second axially outer portions and of the or each central rib j,
Max(N1/R1; N2/R2; MyRj) is the maximum value of the ratio between the number of major transverse cuts and the pitch ratio of the first and second axially outer portions and of the or each central rib j.

In these preferred embodiments, the overall pitch ratio is determined between the first axially outer portion, the or each central rib j and the second axially outer portion. The lower this overall pitch ratio, the more the acoustic energy is spread, thereby making it possible to reduce the noise generated by the tyre. Nevertheless, it is preferable not to have too low an overall pitch ratio since this would generate excessive differences in stiffness and would increase the risk of localized wear.

In preferred and optional embodiments, at least 50%, preferably at least 75% and more preferably each of the major transverse cuts formed in the or each central rib i has/have, in at least one zone, a width less than or equal to 0.50 mm. In order to conceal the potential differences in stiffness between the or each central rib i and the first and second axially lateral portions, the or each central rib i is stiffened in a comparable manner such that there is even wear between the or each central rib i and the first and second axially lateral portions.

Preferably, at least 50%, preferably at least 75% and more preferably each of the major transverse cuts formed in the or each central rib i has/have, in at least one zone, a width less than or equal to 0.40 mm and more preferably less than or equal to 0.35 mm.

In preferred variants, the zone extends over at least 10% of the height and along at least 10% of the length of at least 50%, preferably at least 75%, and more preferably each of the major transverse cuts formed in the or each central rib i. By increasing the height and the length along which the blocks are able to come into contact with one another, the coming into contact of the leading and trailing faces is made even easier.

Optionally and preferably, the zone extends over a continuous surface representing at least 10%, preferably at least 20% of the surface of each leading and trailing face of at least 50% of the major transverse cuts formed in the or each central rib i. Thus, by virtue of a continuous surface, the capability of the leading and trailing faces to come into contact with respect to spot-like contact points is maximized.

Advantageously, the zone extends over a continuous surface representing at most 80%, preferably at most 50% of the surface of each leading and trailing face of at least 50% of the major transverse cuts formed in the or each central rib i.

Even more preferably, the zone extends over a continuous surface representing at least 10%, preferably at least 20% and at most 80%, preferably at most 50% of the surface of each leading and trailing face of at least 75% and very preferably of each of the major transverse cuts formed in the or each central rib i.

In preferred and optional embodiments, each major transverse cut formed in the or each central rib i has a radially median portion, a radially outer portion arranged radially on the outside of the radially median portion, and a radially inner portion arranged radially on the inside of the radially median portion, the radially median portion extending radially over a height equal to 50% of the height of said major transverse cut, each radially inner and outer portion extending radially over a height equal to 25% of the height of said major transverse cut, and the zone of at least 50% of the major transverse cuts formed in the or each central rib i, preferably of at least 75% of the major transverse cuts formed in the or each central rib i, and more preferably of each major transverse cut formed in the or each central rib i is situated at least partially in the median portion.

In a similar way to the first and second major transverse cuts, this ensures that the contact between the leading face and the trailing face occurs in the median portion. This thus allows the major transverse cuts to have a relatively great width in the other portions, in particular in the radially outer portion, thereby making it possible to increase the area void ratio.

In certain preferred variants, there is at least one central rib i comprising the same number of major transverse cuts as the first axially lateral portion and/or there is at least one central rib i comprising the same number of major transverse cuts as the second axially lateral portion. These variants make it possible to create visual continuity between the first and second axially lateral portions and some of the central ribs. Even more preferably, the or one of the ribs comprising the same number of major transverse cuts as the first axially lateral portion is the rib axially adjacent to the first axially lateral portion and/or the or one of the ribs comprising the same number of major transverse cuts as the second axially lateral portion is the rib axially adjacent to the second axially lateral portion.

In embodiments for further reducing the noise generated by the tyre, each major transverse cut is formed in the or each central rib i until opening into each of the first and second circumferential cuts axially delimiting said central rib i in, respectively, first and second opening zones, and the azimuth of a point of the first opening zone of a first major transverse cut formed in said central rib i is substantially aligned circumferentially with the azimuth of a point of the second opening zone of a second major transverse cut formed in said central rib i, the first and second major transverse cuts formed in said central rib i being circumferentially adjacent.

The expression “substantially aligned” means that the azimuths are circumferentially distant from one another by at most 5% of the mean distance separating the first and second circumferentially adjacent major transverse cuts formed in said central rib i.

Preferably, each main circumferential cut has a depth greater than or equal to 75%, and more preferably greater than or equal to 90%, of the tread pattern height.

In embodiments in which the main circumferential cuts are relatively deep and suitable for tyres for passenger vehicles or vans, each main circumferential cut has a depth ranging from 4.0 mm to the tread pattern height, preferably ranging from 5.0 mm to the tread pattern height and more preferably ranging from 5.5 mm to the tread pattern height.

In embodiments in which the main circumferential cuts are relatively wide main circumferential grooves that are suitable for tyres for passenger vehicles or vans, each main circumferential cut has an axial width greater than or equal to 1.0 mm, preferably greater than or equal to 5.0 mm and more preferably ranging from 5.0 mm to 13.0 mm.

In the conventional way, the tyre comprises a crown, two sidewalls, and two beads, each sidewall connecting each bead to the crown. Again in the conventional way, the crown comprises the tread and a crown reinforcement arranged radially on the inside of the tread. The tyre also comprises a carcass reinforcement that is anchored in each bead and extends radially in each sidewall and axially in the crown, radially on the inside of the crown reinforcement.

In the conventional way, the crown reinforcement comprises at least one crown layer comprising reinforcing elements. These reinforcing elements are preferably textile or metallic filamentary elements.

In embodiments for obtaining performance aspects of tyres known as radial tyres, for example as defined by the ETRTO, the carcass reinforcement comprises at least one carcass layer, the or each carcass layer comprising filamentary carcass reinforcing elements, each filamentary carcass reinforcing element extending substantially in a main direction that forms an angle, in terms of absolute value, ranging from 80° to 90° with the circumferential direction of the tyre.

The invention will be understood better from reading the following description, which is given solely by way of non-limiting example and with reference to the drawings, in which:

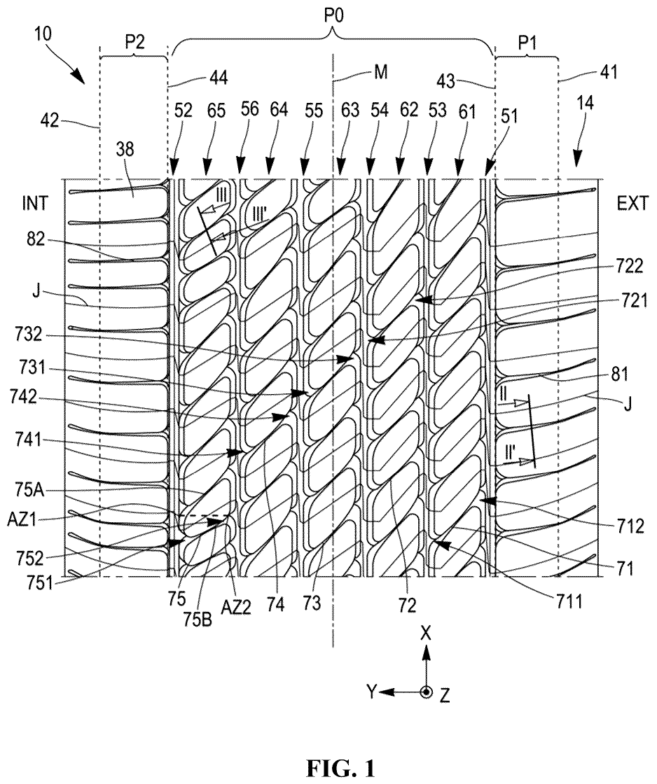

FIG. 1 is a top view of the tread of a tyre according to the invention,

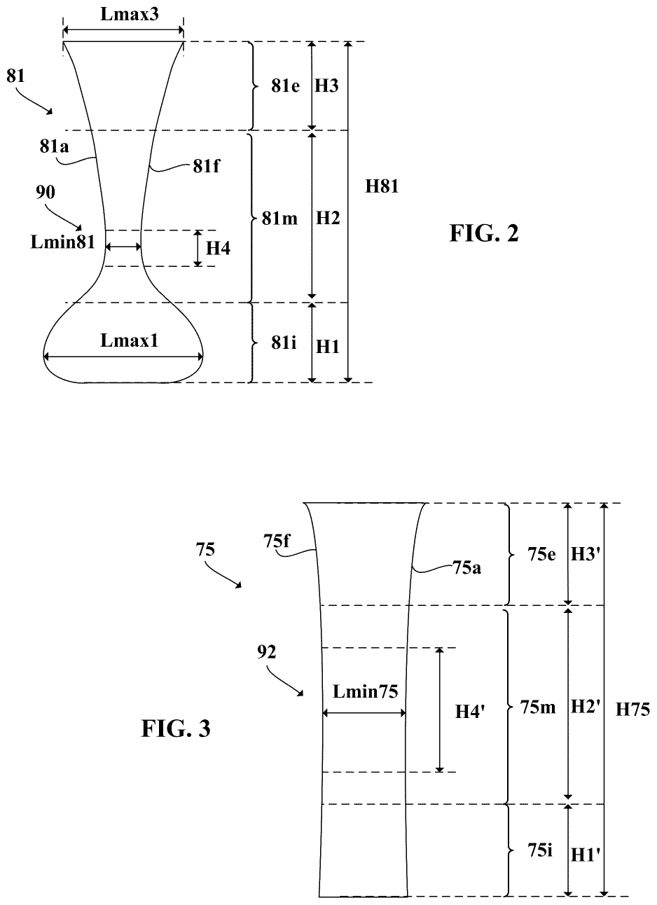

FIG. 2 is a view in cross section of a major transverse cut on the plane II-II′ in FIG. 1,

FIG. 3 is a view in cross section of a major transverse cut on the plane III-III′ in FIG. 1, and

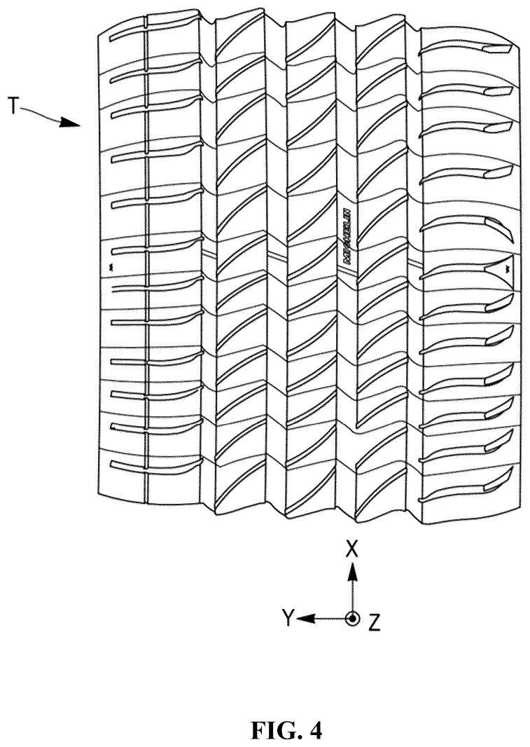

FIG. 4 is a view, similar to the one in FIG. 1, of a control tyre that makes it possible to demonstrate the advantage of the invention.

A frame of reference X, Y, Z corresponding to the usual axial (Y), radial (Z) and circumferential (X) directions, respectively, of a tyre is shown.

With reference to FIG. 1, the tyre according to the invention is denoted by the general reference 10. The tyre 10 has a substantially toroidal shape about an axis of revolution substantially parallel to the axial direction Y. The tyre 10 is intended for a passenger vehicle and has dimensions 235/55 R19. The tyre 10 is a summer tyre. The tyre 10 is shown as new, i.e. when it has not yet been run.

The tyre 10 comprises a tread 14 intended to come into contact with the ground during running. The tyre 10 also comprises a conventional structure, as described, for example, in applications WO2021250331, WO2022074341 or WO2022069819.

The tyre 10 is obtained by moulding a green tyre in a mould comprising a plurality of different patterns. In FIG. 1, the joins J between two circumferentially adjacent patterns are shown by continuous lines. In the present case, the mould comprises three different patterns which have been distributed randomly so as to mould the tread 14.

The tread 14 comprises a tread surface 38 via which the tread 14 is intended to come into contact with the ground when the tyre 10 is running on the ground. The tread surface 38 is axially delimited by first and second axial edges 41, 42. The tyre 10 has an inner side INT and an outer side EXT imposed when the tyre 10 is mounted on a vehicle.

The tread 14 comprises an axially central portion P0 and first and second axially lateral portions P1, P2 arranged axially on the outside of the axially central portion P0 axially on either side of the axially central portion P0 with respect to the median plane M of the tyre 10. The first axially lateral portion P1 is arranged on the same side of the median plane as the outer side EXT and the second axially lateral portion P2 is arranged on the same side of the median plane as the inner side INT.

The tread 14 comprises N>1 main circumferential cuts, in this case N=6 main circumferential grooves denoted by the references 51, 52, 53, 54, 55, 56. The axially outer main circumferential cuts 51, 52 referred to as first and second axially outer main circumferential cuts 51, 52 are arranged axially on either side of the median plane M of the tyre 10 and are the axially outermost main circumferential cuts of the tread 14.

The first axially lateral portion P1 and the second axially lateral portion P2 are arranged axially on the outside of the first axially outer main circumferential cut 51 and of the second axially outer main circumferential cut 52, respectively. The first axially lateral portion P1 extends axially from the first axial edge 41 of the tread surface 38 to the axially outer edge 43 of the first axially outer main circumferential cut 51. The second axially lateral portion P2 extends axially from the second axial edge 42 of the tread surface 38 to the axially outer edge 44 of the second axially outer main circumferential cut 52.

Each main circumferential cut 51 to 56 has a depth ranging from 4.0 mm to the tread pattern height Hs, preferably ranging from 5.0 mm to the tread pattern height Hs and more preferably ranging from 5.5 mm to the tread pattern height Hs. Each depth is greater than or equal to 50%, preferably 75% and more preferably greater than or equal to 90% of the tread pattern height. In this case, Hs=6.3 mm, the depth of each first and second axially outer main circumferential cut 51, 52 is equal to 5.8 mm, the depth of each main circumferential cut 53, 56 is equal to 6.1 mm, and the depth of each main circumferential cut 54, 55 is equal to 6.3 mm.

Each main circumferential cut 51 to 56 respectively has an axial width greater than or equal to 1.0 mm, preferably greater than or equal to 5.0 mm and more preferably ranging from 5.0 mm to 13.0 mm. In this case, the width of each first and second axially outer main circumferential cut 51, 52 and each main circumferential cut 53, 56 is equal to 8.4 mm, the width of the main circumferential cut 54 is equal to 9.0 mm, and the width of the main circumferential cut 55 is equal to 9.5 mm.

The axially central portion P0 comprises k≥1 central ribs, in this case k=5 central ribs 61, 62, 63, 64, 65. Each central rib 61 to 65 is arranged axially between first and second axially adjacent main circumferential cuts from among the main circumferential cuts 51 and 56, and in this case delimited axially by said first and second axially adjacent main circumferential cuts from among the main circumferential cuts 51 to 56.

The first axially lateral portion P1 comprises N1 first transverse cuts 81 formed in the first axially lateral portion P1. The second axially lateral portion P2 comprises N2 second transverse cuts 82 formed in the second axially lateral portion P2.

Each central rib 61, 62, 63, 64 and 65 comprises respectively M61, M62, M63, M64 and M65 transverse cuts formed in said central rib 61, 62, 63, 64 and 65 and respectively denoted by the references 71, 72, 73, 74 and 75.

Each transverse cut 81, 82 extends over an axial width greater than or equal to 50% of the respective axial width of each first and second axially lateral portion P1, P2, in this case over an axial width equal greater than the axial width of each first and second axially lateral portion P1, P2. Thus, each first and second transverse cut 81, 82 extends axially from respectively each first and second axial edge 41, 42 until opening respectively into each first and second axially outer main circumferential cut 51, 52. Each transverse cut 81, 82 has a depth greater than or equal to 50% of the tread pattern height Hs of the tyre 10, in this case a depth equal to 5.3 mm.

Each transverse cut 71, 72, 73, 74 and 75 extends over an axial width greater than or equal to 50% of the respective axial width of each central rib 61, 62, 63, 64 and 65, in this case over an axial width equal to 100% of the axial width of each central rib 61, 62, 63, 64 and 65. Thus, each transverse cut 71, 72, 73, 74 and 75 extends axially from each first main circumferential cut 51, 53, 54, 55, 56, respectively, until opening into each second main circumferential cut 53, 54, 55, 56, 52, respectively. Each transverse cut 71, 72, 73, 74 and 75 has a depth greater than or equal to 50% of the tread pattern height Hs of the tyre 10, in this case a depth equal to 6.0 mm for each cut 71, 75, a depth equal to 6.2 mm for each cut 72, 74, and a depth equal to 6.3 mm for each cut 73.

On account of the proportion of the axial width of the axially lateral portion or of the central rib over which they extend and of their depth with respect to the tread pattern height, the transverse cuts 81, 82, 71, 72, 73, 74 and 75 are referred to as major transverse cuts.

Each central rib 61, 62, 65 is such that N1≤M61≤Mj<N2 or N1<Mj≤M61≤N2, N1≤M62≤Mj<N2 or N1<Mj≤M62≤N2 and N1≤M65≤Mj<N2 or N1<Mj≤M65≤N2. In the present case, there is at least one central rib from among the central ribs 61, 62, 65 that has the same number of major transverse cuts as the first axially lateral portion P1. In this case, the central rib 61 axially adjacent to the first axially lateral portion P1 and the central rib 62 are such that M61=M62=N1=83. There is also at least one central rib from among the central ribs 61, 62, 65 that has the same number of major transverse cuts as the second axially lateral portion P2. In this case, the central rib 65 axially adjacent to the second axially lateral portion P2 is such that M65=N2=134. It will be noted that N1 and N2 satisfy N2/N1≥1.30, preferably N2/N1≥1.50 and N2/N1≤2.00, preferably N2/N1≤1.75 and in this case N2/N1=1.61.

There is at least one central rib j from among the central ribs 61 to 65 that comprises Mj major transverse cuts such that N1<Mj<N2. In this case, the central ribs 63, 64 are such that M63=M64=106. It will be noted that N1, N2, M63 and M64 satisfy N2/M63=N2/M64≥1.15 and M63/N1=M64/N1≥1.15 and preferably N2/M63=N2/M64≥1.25 and M63/N1=M64/N1≥1.25. It will also be noted that N2/M63=N2/M64≤1.75 and M63/N1=M64/N1≤1.75, preferably N2/M63=N2/M64≤1.50 and M63/N1=M64/N1≤1.50.

R1 can be defined as the pitch ratio equal to the ratio between the minimum distance between two circumferentially consecutive first major transverse cuts 81, in this case equal to 23.7 mm, and the maximum distance between two circumferentially consecutive first major transverse cuts 81, in this case equal to 33.9 mm. R2 can also be defined as the pitch ratio equal to the ratio between the minimum distance between two circumferentially consecutive second major transverse cuts 82, in this case equal to 14.6 mm, and the maximum distance between two circumferentially consecutive second major transverse cuts 82, in this case equal to 20.9. Lastly, R63 and R64 can be defined as the pitch ratio equal to the ratio between the minimum distance between two circumferentially consecutive major transverse cuts 73, 74 in each central rib 63, 64, in this case equal to 18.5 mm, and the maximum distance between two circumferentially consecutive major transverse cuts 73, 74 in each central rib 63, 64, in this case equal to 20.9 mm. In this case, R1=R2=R63=R64=0.70.

This makes it possible to define levels of overlap T1,63=T1,64=[(N1/R1)−(M63×R63)]/[(M63/R63)−(N1×R1)]=[(N1/R1)−(M64×R64)]/[(M64/R64)−(N1×R1)] between the first axially lateral portion P1 and each central rib 63, 64. This also makes it possible to define levels of overlap T63,2=T64,2=[(M63/R63)−(N2×R2)]/[(N2/R2)−(M63×R63)]=[(M64/R64)−(N2×R2)]/[(N2/R2)−(M64×R64)] between the second axially lateral portion P2 and each central rib 63, 64.

This also makes it possible define an overall pitch ratio Rpg=[Min(N1×R1; N2×R2; M63×R63; M64×R64)/Max(N1/R1; N2/R2; M63/R63; M64/R64)]\hat{ }(0.5) in which Min(N1×R1; N2×R2; M63×R63; M64×R64) is the minimum value of the product of the number of major transverse cuts and the pitch ratio of the first and second axially outer portions P1, P2 and of each central rib 63, 64, in this case the product of the number N1 of major transverse cuts 81 in the first axially outer portion P1 and the pitch ratio R1, and in which Max(N1/R1; N2/R2; M63/R63; M64/R64) is the maximum value of the ratio between the number of major transverse cuts and the pitch ratio of the first and second axially outer portions P1, P2 and of each central rib 63, 64, in this case the ratio between the number N2 of major transverse cuts 82 in the second axially outer portion P2 and the pitch ratio R2.

T1,63, T1,64, T63,2 et T64,2 satisfy, on the one hand. 0.40≤T1,63=T1,64≤0.60 and, on the other hand, 0.40≤T63,2=T64,2≤0.60, and lastly 0.50≤Rpg≤0.60. In this case, T1.63=T1.64=0.48, T63,2=T64,2=0.49 and Rpg=0.55.

The tyre 10 has a diameter equal to 741 mm and a circumference C equal to 2326.8 mm such that, on the one hand, the ratio C/N1 ranges from 24 to 30, preferably from 27 to 29, and in this case C/N1=28 and, on the other hand, the ratio C/N2 ranges from 14 to 20, preferably from 16 to 19, and in this case C/N2=17, and lastly, the ratio C/M63=C/M64 ranges from 18 to 23, preferably from 20 to 23, and in this case C/M63=C/M64=22.

Each major transverse cut 71, 72, 73, 74 and 75 formed respectively in each central rib 61, 62, 63, 64 and 65 opens into each of the first and second circumferential cuts axially delimiting said central rib 61, 62, 63, 64 and 65 in, respectively, first and second opening zones 711, 712, 721, 722, 731, 732, 741, 742, 751, 752.

Considering, by way of example, circumferentially adjacent first and second major transverse cuts 75A, 75B formed in the central rib 65, the azimuth AZ1 of a point of the first opening zone 751 of the first major transverse cut 75A is substantially aligned circumferentially with the azimuth AZ2 of a point of the second opening zone 752 of the second major transverse cut 75B. This feature of circumferential alignment is also reproduced by the cuts 71, 72, 73 and 74 formed respectively in each central rib 61, 62, 63 and 64.

The major transverse cuts 81, 82 and 71 to 75 and the main circumferential cuts 51 to 56 delimit a plurality of blocks bearing chamfers on each of their circumferential edges and each of their transverse edges.

FIGS. 2 and 3 respectively show a first major transverse cut 81 and a major transverse cut 75. The first major transverse cuts 81 are all identical to one another and, give or take a homothetic factor, are identical to the second major transverse cuts 82. The major transverse cuts 75 are, give or take a homothetic factor, identical to the major transverse cuts 71, 72, 73 and 74.

With reference to FIG. 2, at least 50%, preferably at least 75% of the first major transverse cuts 81 and in this case each first major transverse cut 81 has/have a radially inner portion 81i, a radially median portion 81m and a radially outer portion 81e. The radially inner portion 81i is arranged radially on the inside of the radially median portion 81m. The radially outer portion 81e is arranged radially on the outside of the radially median portion 81m. The radially inner portion 81i is the radially innermost portion of the first major transverse cut 81, and the radially outer portion 81e is the radially outermost portion of the first major transverse cut 81. The radially median portion 81m extends radially over a height H2 equal to 50% of the height H81 of the first major transverse cut 81. Each radially inner portion 81i and radially outer portion 81e extends radially over, respectively, a height H1, H3 equal to 25% of the height H81 of the first major transverse cut 81.

The radially inner portion 81i has a maximum width Lmax1 strictly greater than the maximum width of the radially outer portion Lmax3. In the section plane II-II′, each first major transverse cut 81 has a minimum width Lmin81 in this case equal to 0.30 mm. This is also the case for the second major transverse cuts 82. In this case, Lmax1=1.16 mm and Lmax3=1.00 mm.

At least 50%, preferably at least 75% of the first major transverse cuts 81 and in this case each first major transverse cut 81 has/have, in at least one zone 90, a width less than or equal to 0.50 mm, preferably less than or equal to 0.40 mm and more preferably less than or equal to 0.35 mm. In the example shown in FIG. 2, the width of at least 50%, preferably of 75% and in this case of each of the first major transverse cuts 81 is less than or equal to 0.50 mm, preferably less than or equal to 0.40 mm and more preferably less than or equal to 0.35 mm over at least 10% of its height H81, in this case represented by the height portion H4, and along at least 10% of its length. The zone 90 of at least 50%, preferably at least 75% of the first major transverse cuts 81 and in this case of each first major transverse cut 81 is situated at least partially, and in this case entirely in the radially median portion 81m. The zone 90 extends over a continuous surface representing at least 10%, and at most 80%, preferably at most 50% of the surface of each leading face 81a and trailing face 81f of each first major transverse cut 81.

As indicated above, this is also the case for the second major transverse cuts 82.

With reference to FIG. 3, each major transverse cut 75 has a width that varies on progressing radially in the major transverse cut 75. At least 50%, preferably at least 75% of each major transverse cut 75 and in this case each major transverse cut 75 has/have a radially inner portion 75i, a radially median portion 75m and a radially outer portion 75e. The radially inner portion 75i is arranged radially on the inside of the radially median portion 75m. The radially outer portion 75e is arranged radially on the outside of the radially median portion 75m. The radially inner portion 75i is the radially innermost portion of the major transverse cut 75, and the radially outer portion 75e is the radially outermost portion of the major transverse cut 75. The radially median portion 75m extends radially over a height H2′ equal to 50% of the height H75 of the major transverse cut 75. Each radially inner portion 75i and radially outer portion 75e extends radially over, respectively, a height H1′, H3′ equal to 25% of the height H75 of the major transverse cut 75.

At least 50%, preferably at least 75% and in this case each of the major transverse cuts 75 formed in the central rib 65 has/have, in at least one zone 92, a width less than or equal to 0.50 mm, preferably less than or equal to 0.40 mm and more preferably less than or equal to 0.35 mm. In the example shown in FIG. 3, the width of at least 50%, preferably of 75% and in this case of each of the major transverse cuts 75 is less than or equal to 0.50 mm, preferably less than or equal to 0.40 mm and more preferably less than or equal to 0.35 mm over at least 10% of its height H, in this case represented by the height portion H4′, and along at least 10% of its length.

The zone 92 extends over a continuous surface representing at least 10%, preferably at least 20% and at most 80%, preferably at least 50% of the surface of each leading face 75a and trailing face 75f of each major transverse cut 75.

In the section plane III-III′, each major transverse cut 75 has a minimum width Lmin 75 in this case equal to 0.24 mm. The zone 92 of at least 50%, preferably of at least 75% and in this case of each of the major transverse cuts 75 is situated at least partially, and in this case entirely in the radially median portion 75m. This is also the case for the major transverse cuts 71, 72, 73, 74.

### Comparative Tests

### Wear Measurements

The above-described tyre 10 was compared with a control tyre T, the tread of which is illustrated in FIG. 4. The treads of the tyre 10 and control tyre T are made from identical materials. Unlike the tyre 10, the control tyre T is such that N1=N2 and such that there is no zone in which the width of the major transverse cuts formed in each axially lateral portion is less than or equal to 0.50 mm. Specifically, the major transverse cuts formed in each axially lateral portion have widths equal to 1.0 mm, 1.2 mm and 1.5 mm depending on the cuts.

Four tyres 10 and T were made to run each time on a single vehicle and the wearing of the tyres mounted at the front of the vehicle was measured as a function of the mileage, approximately 15000 km. Then, in order to shorten the text, the wear was extrapolated until one of the portions of the tread reaches the maximum wear indicated by the regulatory wear indicator. The average over the two tyres mounted at the front of the vehicle was then calculated.

The maximum mileage reached by each tyre (which reflects the service life of the tyre) and the loss of mass undergone by each tyre on reaching this maximum mileage was then collated. The results are collated in the following Table 1, using the tyre T as base 100.

TABLE 1

| | T | 10 |
|---|---|---|
| Service life (base 100) | 100 | 117 |
| Loss of mass (base 100) | 100 | 94 |

In contrast to the control tyre T, for which the service life is determined by the regulatory wear indicator being reached prematurely in the axially lateral portion arranged on the inner side of the vehicle, the service life of the tyre 10 is determined by the regulatory wear indicator being reached later in the axially lateral portion arranged on the inner side of the vehicle and almost simultaneously with the regulatory wear indicator being reached in the axially lateral portion arranged on the outer side of the vehicle. Thus, the invention made the wearing of the tread more even and avoided the wear limit being reached prematurely by the stiffest portion of the tyre. The tyre according to the invention can therefore cover a mileage greater than that of the control tyre T.

This is confirmed by the loss of mass, which is greater for the tyre 10 compared with the loss of mass of the control tyre T. Specifically, on account of more even wear over the entire tread, the tyre 10 loses more mass before the maximum mileage is reached than the control tyre T, the majority of portions of which still have a large amount of material to be worn down, while only one portion has been worn down (in this case the axially lateral portion arranged on the inner side of the vehicle) to such an extent that the regulatory wear indicator has been reached.

### Evaluation of Noise

Noise tests were carried out in order to evaluate the cavity noise at speeds less than 90 km/h, the beating noise and the braking noise of the tyre 10, of the tyre T and of a reference tyre R that is particularly quiet. These tests were carried out subjectively by a driver and the results are collated in the following Table 2, in which:
The sign “=” indicates noise substantially equivalent to that of the reference tyre R,
The sign “−” indicates a slight increase in the noise compared with the reference tyre R,
The sign “−−” indicates a large increase in the noise compared with the reference tyre R,
The sign “+” indicates a slight decrease in the noise compared with the reference tyre R.

TABLE 2

| | T | 10 |
|---|---|---|
| Cavity noise | −− | = |
| Beating noise | − | + |
| Braking noise | = | + |

It will be noted that the tyre 10 according to the invention is quieter than the control tyre T and even quieter than the reference tyre R.

The invention is not limited to the embodiment described above.

1.-15. (canceled)

16. A tire comprising a tread intended to come into contact with a ground via a tread surface when the tire is running, the tread comprising:
main circumferential cuts having a depth greater than or equal to 50% of a tread pattern height, comprising first and second axially outer main circumferential cuts arranged axially on either side of a median plane of the tire, the first and second axially outer main circumferential cuts being axially outermost main circumferential cuts of the tread;
a first axially lateral portion that is arranged axially on an outside of the first axially outer main circumferential cut and extends axially from a first axial edge of the tread surface to an axially outer edge of the first axially outer main circumferential cut;
a second axially lateral portion that is arranged axially on an outside of the second axially outer main circumferential cut and extends axially from a second axial edge of the tread surface to an axially outer edge of the second axially outer main circumferential cut,
the first axially lateral portion comprising N1 first transverse cuts formed in the first axially lateral portion,
the second axially lateral portion comprising N2 second transverse cuts formed in the second axially lateral portion, where N2>N1, and
each first and second transverse cut is a major transverse cut, extending over an axial width greater than or equal to 50% of a respective axial width of each first and second axially lateral portion and having a depth greater than or equal to 50% of the tread pattern height of the tire,
wherein at least 50% of the first major transverse cuts and at least 50% of the second major transverse cuts have, in at least one zone, a width less than or equal to 0.50 mm,
wherein the tire comprises k≥1 central ribs i delimited axially by first and second axially adjacent main circumferential cuts, the or each central rib i comprising Mi>1 transverse cuts formed in the central rib i, each major transverse cut formed in the central rib i extending over an axial width greater than or equal to 50% of an axial width of the central rib i and having a depth greater than or equal to 50% of the tread pattern height of the tire, and
wherein there is at least one central rib j comprising Mj>1 major transverse cuts formed in said central rib j such that N1<Mj<N2.

17. The tire according to claim 16, wherein at least 75% of the first major transverse cuts and at least 75% of the second major transverse cuts have, in the at least one zone, a width less than or equal to 0.35 mm.

18. The tire according to claim 16, wherein the at least one zone extends over at least 10% of the height and along at least 10% of the length of at least 50% of the first major transverse cuts and of at least 50% of the second major transverse cuts.

19. The tire according to claim 16, wherein each first and second major transverse cut has a radially median portion, a radially outer portion arranged radially on an outside of the radially median portion, and a radially inner portion arranged radially on an inside of the radially median portion, the radially median portion extending radially over a height equal to 50% of a height of the first and second major transverse cut, each radially inner portion and radially outer portion extending radially over a height equal to 25% of the height of the first and second major transverse cut, and the at least one zone of at least 50% of the first major transverse cuts and of at least 50% of the second major transverse cuts.

20. The tire according to claim 16, wherein at least 50% of the first major transverse cuts and at least 50% of the second major transverse cuts have a radially inner portion and a radially outer portion arranged radially on the outside of the radially inner portion, the radially inner portion being the radially innermost portion of the first and second major transverse cut and the radially outer portion being the outermost portion of the first and second major transverse cut, the radially inner portion having a maximum width strictly greater than a maximum width of the radially outer portion.

21. The tire according to claim 16, wherein each first and second major transverse cut extends axially from respectively each first and second axial edge of the tread surface until opening respectively into each first and second axially outer main circumferential cut.

22. The tire according to claim 16, wherein N2/N1≥1.30.

23. The tire according to claim 16, wherein each major transverse cut formed in each central rib i extends axially from each first main circumferential cut until opening into each second main circumferential cut.

24. The tire according to claim 16, wherein, with each central rib i other than the central rib j comprising Mm>1 major transverse cuts that are formed in the central rib i other than the central rib j and extend over an axial width greater than or equal to 50% of the axial width of the central rib i other than the central rib j and have a depth greater than or equal to 50% of the tread pattern height of the tire, each central rib i other than the central rib j is such that N1≤Mm≤Mj<N2 or N1<Mj≤Mm≤N2.

25. The tire according to claim 16, wherein N2/Mj≥1.15 and Mj/N1≥1.15.

26. The tire according to claim 16, wherein N1, N2 and Mj are such that:
$$\begin{matrix}0.4 \leq [ ( N 1 / R 1 ) - ( Mj \times Rj ) ] / [ ( Mj / Rj ) - ( N 1 \times R 1 ) ] \leq 0.6 , and \\ 0.4 \leq [ ( Mj / Rj ) - ( N 2 \times R 2 ) ] / [ ( N 2 / R 2 ) - ( Mj \times Rj ) ] \leq 0.6 ,\end{matrix}$$
where:
R1 is a pitch ratio equal to a ratio between a minimum distance between two first circumferentially consecutive major transverse cuts and a maximum distance between two first circumferentially consecutive major transverse cuts,
R2 is a pitch ratio equal to a ratio between a minimum distance between two second circumferentially consecutive major transverse cuts and a maximum distance between two second circumferentially consecutive major transverse cuts, and
Rj is a pitch ratio equal to a ratio between a minimum distance between two circumferentially consecutive major transverse cuts of the or each central rib j and a maximum distance between two circumferentially consecutive major transverse cuts of the or each central rib j.

27. The tire according to claim 16, wherein N1, N2 and Mj are such that 0.50≤[Min(N1×R1; N2×R2; Mj×Rj)/Max(N1/R1; N2/R2; Mj/Rj)]\hat{ }(0.5)≤0.60, where:
R1 is a pitch ratio equal to a ratio between a minimum distance between two first circumferentially consecutive major transverse cuts and a maximum distance between two first circumferentially consecutive major transverse cuts,
R2 is a pitch ratio equal to a ratio between a minimum distance between two second circumferentially consecutive major transverse cuts and a maximum distance between two second circumferentially consecutive major transverse cuts,
Rj is a pitch ratio equal to a ratio between a minimum distance between two circumferentially consecutive major transverse cuts of the or each central rib j and a maximum distance between two circumferentially consecutive major transverse cuts of the or each central rib j,
Min(N1×R1; N2×R2; Mj×Rj) is a minimum value of a product of a number of major transverse cuts and a pitch ratio of the first and second axially outer portions and of the or each central rib j, and
Max(N1/R1; N2/R2; Mj/Rj) is a maximum value of a ratio between a number of major transverse cuts and the pitch ratio of the first and second axially outer portions and of the or each central rib j.

28. The tire according to claim 16, wherein at least 50% of the major transverse cuts formed in the or each central rib i has, in another at least one zone, a width less than or equal to 0.50 mm.

29. The tire according to claim 28, wherein the another at least one zone extends over at least 10% of the height and along at least 10% of the length of at least 50% of the major transverse cuts formed in the or each central rib i.

30. The tire according to claim 28, wherein each major transverse cut formed in the or each central rib i has a radially median portion, a radially outer portion arranged radially on an outside of the radially median portion, and a radially inner portion arranged radially on an inside of the radially median portion, the radially median portion extending radially over a height equal to 50% of the height of the major transverse cut, each radially inner and outer portion extending radially over a height equal to 25% of the height of the major transverse cut, and the another at least one zone of at least 50% of the major transverse cuts formed in the or each central rib i is situated at least partially in the median portion.
